(19) United States
(12) Patent Application Publication
(10) Pub. No.: US 2023/0169073 A1
(43) Pub. Date: Jun. 1, 2023

(54) Determining Data Object Attribute Values Based On Hierarchical Rules

(71) Applicant: Callidus Software Inc., San Ramon, CA (US)

(72) Inventors: Wojtek Kalata, Denver, CO (US); Imran Mohammed, Hyderabad (IN); Vijaya Prudhvi Krishna Somisetti, Hyderabad (IN); Eric Hagen, Danville, CA (US); Yako Blagoev, Phoenixville, PA (US); Abhinaiy Karavadi, Hyderabad (IN); Naveen Kumar Gandham, Hyderabad (IN)

(21) Appl. No.: 17/588,062

(22) Filed: Jan. 28, 2022

(30) Foreign Application Priority Data
Nov. 26, 2021 (IN) 202141054646

(51) Int. Cl. G06F 16/242; G06F 16/28; G06F 16/23

(52) U.S. Cl. CPC G06F 16/2448; G06F 16/282; G06F 16/23

(57) ABSTRACT

Some embodiments provide a program that receives a request to apply a hierarchical rule definition to a set of data objects. Each data object in the set of data objects includes a set of attributes. The program further retrieves the hierarchical rule definition from a set of hierarchical rule definitions. Each hierarchical rule definition in the set of hierarchical rule definitions includes a hierarchy of rules. Each rule in the hierarchy of rules includes a set of criteria and a set of actions that are performed when the set of criteria are satisfied. The program also applies the hierarchical rule definition to each data object in a subset of the set of data objects by traversing the hierarchy of rules of the hierarchical rule definition and modifying the data object based on sets of criteria and sets of actions specified in the hierarchy of rules.

### CROSS-REFERENCE TO RELATED APPLICATION

The present application claims the benefit and priority of India Provisional Application No. 202141054646, filed Nov. 26, 2021, the entire contents of which are incorporated herein by reference in its entirety for all purposes.

### BACKGROUND

Enterprise software applications are typically used by organizations to assist in and/or enhance the operation of the organizations in any number of different areas. Examples of area in which enterprise software applications can provide services include enterprise resource planning, customer relationship management, supply chain management, human resource management, business intelligence, etc. Many, if not all, enterprise software applications employ and/or generate data associated with organizations. Examples of such data include employee data, financial data, customer data, supplier data, vendor data, etc.

### SUMMARY

In some embodiments, a non-transitory machine-readable medium stores a program executable by at least one processing unit of a device. The program receives a request to apply a hierarchical rule definition to a set of data objects. Each data object in the set of data objects includes a set of attributes. The program further retrieves the hierarchical rule definition from a set of hierarchical rule definitions. Each hierarchical rule definition in the set of hierarchical rule definitions includes a hierarchy of rules. Each rule in the hierarchy of rules includes a set of criteria and a set of actions that are performed when the set of criteria are satisfied. The program also applies the hierarchical rule definition to each data object in a subset of the set of data objects by traversing the hierarchy of rules of the hierarchical rule definition and modifying the data object based on sets of criteria and sets of actions specified in the hierarchy of rules.

In some embodiments, the set of criteria of a particular rule in the hierarchy of rules includes a child rule evaluation type. The set of actions of the particular rule in the hierarchy of rules includes setting a specified value for a particular attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes evaluating at least one child rule of the particular rule in the hierarchy of rules on the data object and, based on the evaluation, setting a value of the particular attribute of the data object to the specified value.

In some embodiments, the set of criteria of a particular rule in the hierarchy of rules includes a first value for a first attribute in the set of attributes satisfies a condition. The set of actions of the particular rule in the hierarchy of rules includes setting a second value for a second attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes determining whether the first value for the first attribute of the data object satisfies the condition and, based on the determination, setting a value of the second attribute of the data object to the second value.

In some embodiments, each hierarchical rule definition in the set of hierarchical rule definitions further includes a set of data object filters. The program may further apply the set of data object filters on the set of data objects to determine the subset of the set of data objects. The hierarchical rule definition may further include an apply to child data object option. The set of attributes includes a parent data object identifier (ID). When the apply to child data object option is enabled, applying the hierarchical rule definition to each data object in the subset of the set of data objects is further by determining a set of child data objects of the data object based on the parent data object IDs of the set of data objects and modifying each data object in the set of child data objects in the same manner as the modification of the data object.

In some embodiments, a method receives a request to apply a hierarchical rule definition to a set of data objects. Each data object in the set of data objects comprising a set of attributes. The method further retrieves the hierarchical rule definition from a set of hierarchical rule definitions. Each hierarchical rule definition in the set of hierarchical rule definitions includes a hierarchy of rules. Each rule in the hierarchy of rules includes a set of criteria and a set of actions that are performed when the set of criteria are satisfied. The method also applies the hierarchical rule definition to each data object in a subset of the set of data objects by traversing the hierarchy of rules of the hierarchical rule definition and modifying the data object based on sets of criteria and sets of actions specified in the hierarchy of rules.

In some embodiments, the set of criteria of a particular rule in the hierarchy of rules includes a child rule evaluation type. The set of actions of the particular rule in the hierarchy of rules includes setting a specified value for a particular attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes evaluating at least one child rule of the particular rule in the hierarchy of rules on the data object and, based on the evaluation, setting a value of the particular attribute of the data object to the specified value.

In some embodiments, the set of criteria of a particular rule in the hierarchy of rules includes a first value for a first attribute in the set of attributes satisfies a condition. The set of actions of the particular rule in the hierarchy of rules includes setting a second value for a second attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes determining whether the first value for the first attribute of the data object satisfies the condition and, based on the determination, setting a value of the second attribute of the data object to the second value.

In some embodiments, each hierarchical rule definition in the set of hierarchical rule definitions further includes a set of data object filters. The method may further apply the set of data object filters on the set of data objects to determine the subset of the set of data objects. The hierarchical rule definition further includes an apply to child data object option, wherein the set of attributes includes a parent data object identifier (ID). When the apply to child data object option is enabled, applying the hierarchical rule definition to each data object in the subset of the set of data objects is further by determining a set of child data objects of the data object based on the parent data object IDs of the set of data objects and modifying each data object in the set of child data objects in the same manner as the modification of the data object.

In some embodiments, a system includes a set of processing units and a non-transitory machine-readable medium that stores instructions. The instructions cause at least one processing unit to receive a request to apply a hierarchical rule definition to a set of data objects. Each data object in the set of data objects includes a set of attributes. The instructions further cause the at least one processing unit to retrieve the hierarchical rule definition from a set of hierarchical rule definitions. Each hierarchical rule definition in the set of hierarchical rule definitions includes a hierarchy of rules. Each rule in the hierarchy of rules includes a set of criteria and a set of actions that are performed when the set of criteria are satisfied. The instructions also cause the at least one processing unit to apply the hierarchical rule definition to each data object in a subset of the set of data objects by traversing the hierarchy of rules of the hierarchical rule definition and modifying the data object based on sets of criteria and sets of actions specified in the hierarchy of rules.

In some embodiments, the set of criteria of a particular rule in the hierarchy of rules includes a child rule evaluation type. The set of actions of the particular rule in the hierarchy of rules includes setting a specified value for a particular attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes evaluating at least one child rule of the particular rule in the hierarchy of rules on the data object and, based on the evaluation, setting a value of the particular attribute of the data object to the specified value.

In some embodiments, the set of criteria of a particular rule in the hierarchy of rules includes a first value for a first attribute in the set of attributes satisfies a condition. The set of actions of the particular rule in the hierarchy of rules includes setting a second value for a second attribute in the set of attributes. Applying the hierarchical rule definition to each data object in the subset of the set of data objects by traversing the hierarchy of rules of the hierarchical rule definition and modifying the data object based on sets of criteria and sets of actions specified in the hierarchy of rules includes determining whether the first value for the first attribute of the data object satisfies the condition and, based on the determination, setting a value of the second attribute of the data object to the second value.

In some embodiments, each hierarchical rule definition in the set of hierarchical rule definitions further includes a set of data object filters. The instructions further cause the at least one processing unit to apply the set of data object filters on the set of data objects to determine the subset of the set of data objects.

The following detailed description and accompanying drawings provide a better understanding of the nature and advantages of various embodiments of the present disclosure.

### BRIEF DESCRIPTION OF THE DRAWINGS

FIG. 1 illustrates a system for determining data object attributes based on hierarchical rules according to some embodiments.

FIG. 2 illustrates an example data object according to some embodiments.

FIG. 3 illustrates an example hierarchical rule definition according to some embodiments.

FIG. 4 illustrates an example rule according to some embodiments.

FIG. 5 illustrates an example hierarchy of rules according to some embodiments.

FIGS. 6-13 illustrate example rules in the hierarchy of rules illustrated in FIG. 5 according to some embodiments.

FIG. 14 illustrates a process for determining data object attributes based on hierarchical rules according to some embodiments.

FIG. 15 illustrates an exemplary computer system, in which various embodiments may be implemented.

FIG. 16 illustrates an exemplary computing device, in which various embodiments may be implemented.

FIG. 17 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for determining data object attributes based on hierarchical rules. In some embodiments, a computing system may be configured to manage data objects that each have a set of attributes. The set of attributes can be defined by a user of a client device. In addition, the computing system manages a set of hierarchical rules. The set of hierarchical rules can also be defined by the user of the client device. Each hierarchical rule may include a hierarchy of rules. A rule in a hierarchy of rules can include a set of criteria and a set of actions that are to be performed if the set of criteria are satisfied. In some cases, a criterion in a set of criteria specified for a particular rule in a hierarchy of rules may be based on the evaluation of child rules of the particular rule (i.e., rules of which the particular rule is a parent rule). In other cases, a criterion in a set of criteria specified for a particular rule in a hierarchy of rules can be based on attributes of a data object. The computing system can apply the hierarchical rules to data objects to determine values for attributes of the data objects.

The techniques described in the present application provide a number of benefits and advantages over conventional methods for determining attribute values for data objects. For example, in some embodiments, instead of single thread processing and sequential traversing of each hierarchical rule to identify the object attribute(s) to be modified, parallel processing (e.g., in batches) and helper database views, which stores objects, object attribute(s) to be modified, and rule priority information can be implemented for each hierarchical rule. This allows faster processing of hierarchical rules than convention methods of determining attribute values for data objects.

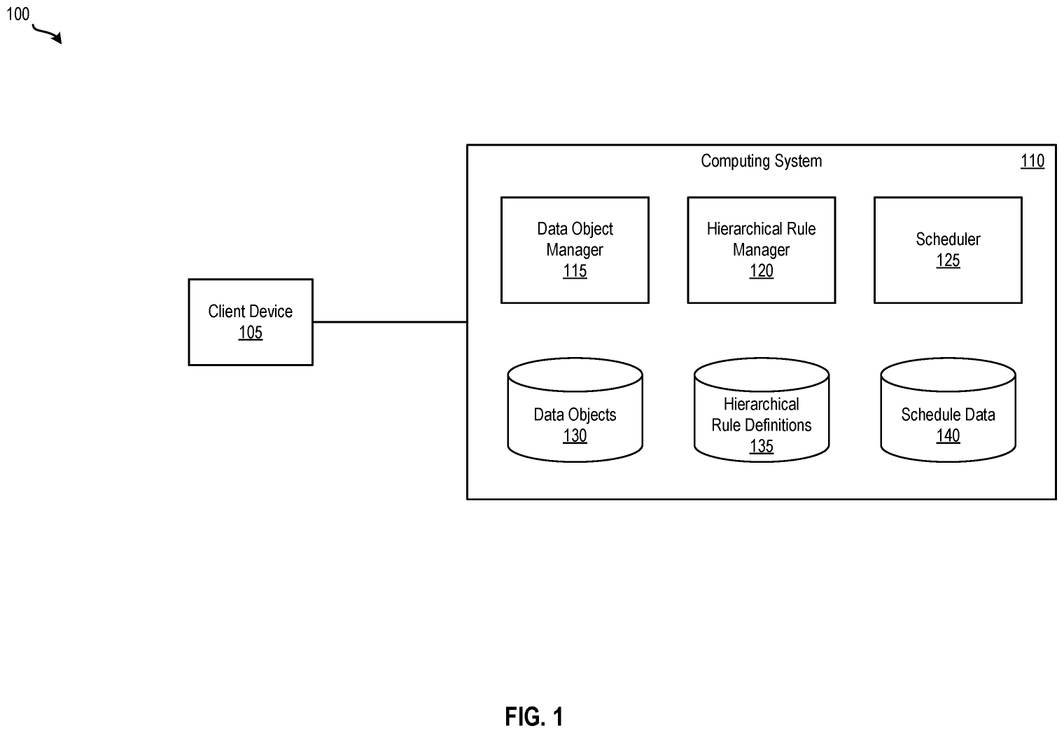

FIG. 1 illustrates a system 100 for determining data object attributes based on hierarchical rules according to some embodiments. As shown, system 100 includes client device 105 and computing system 110. Client device 105 may communicate and interact with computing system 110. For instance, a user of client device 105 can create data objects (e.g., define attributes (e.g., custom-defined attributes) for data objects, provide values for attributes of data objects, etc.) and send them to computing system 105. The user of client device 105 may also edit and/or delete data objects managed by computing system 110. In addition, the user of client device 105 can define hierarchical rules and send them to computing system 110. In some instances, the user of client device 105 may specify a schedule (e.g., specific day(s) and time(s), an interval (e.g., once a day, once a week, once a month, etc.) for computing system 110 to apply a specified set of hierarchical rules to data objects. The user of client device 105 can also make changes to a schedule (e.g., change the times and/or intervals specified in the schedule, specify additional and/or different hierarchical rules in the schedule, specify execution of a sequence of several hierarchy rules, specify the order such a sequence, specify to use the output of the processing of a hierarchical rule as the input to the processing of a next hierarchical rule in a sequence of hierarchical rules, etc.) and send them to computing system 110. In some embodiments, the user of client device 105 may perform these operations through a graphical user interface (GUI) provided by computing system 110. While FIG. 1 depicts one client device, one of ordinary skill in the art will appreciate that system 100 may include any number of additional client devices that are configured the same as or similar to client device 105.

As illustrated in FIG. 1, computing system 110 includes data object manager 115, hierarchical rule manager 120, scheduler 125, data objects storage 130, and hierarchical rule definitions storage 135. Data objects storage 130 is configured to store data objects. Hierarchical rule definitions storage 135 stores hierarchical rule definitions. Schedule data storage 140 is configured to store schedules for applying hierarchical rules to data objects. In some embodiments, a schedule specifies certain day(s) and time(s) and/or an interval (e.g., once a day, once a week, once a month, etc.) at which to apply a set of hierarchical rules to data objects. In some embodiments, storages 130-140 are implemented in a single physical storage while, in other embodiments, storages 130-140 may be implemented across several physical storages. While FIG. 1 shows storages 130-140 as part of computing system 110, one of ordinary skill in the art will appreciate that data objects storage 130, hierarchical rule definitions storage 135, and/or schedule data storage 140 may be external to computing system 110 in some embodiments.

Data object manager 115 is configured to manage data objects. For example, data object manager 115 can receive from client device 105, a data object that was created by a user of client device 105. In response to receiving the data object, data object manager 115 stores it in data objects storage 130. In some instances, data object manager 115 may receive from client device 105 changes to, or a request to delete, a particular data object. In response, data object manager 115 accesses data objects storage 130 and modifies the particular data object stored in data objects storage 130 or deletes it, respectively. Upon receiving them, data object manager 115 accesses data objects storage 130 and stores them in the particular data object stored in data objects storage 130. In some embodiments, data object manager 115 provides client device 105 a GUI through which attributes can be defined for data objects and values can be specified for attributes of data objects.

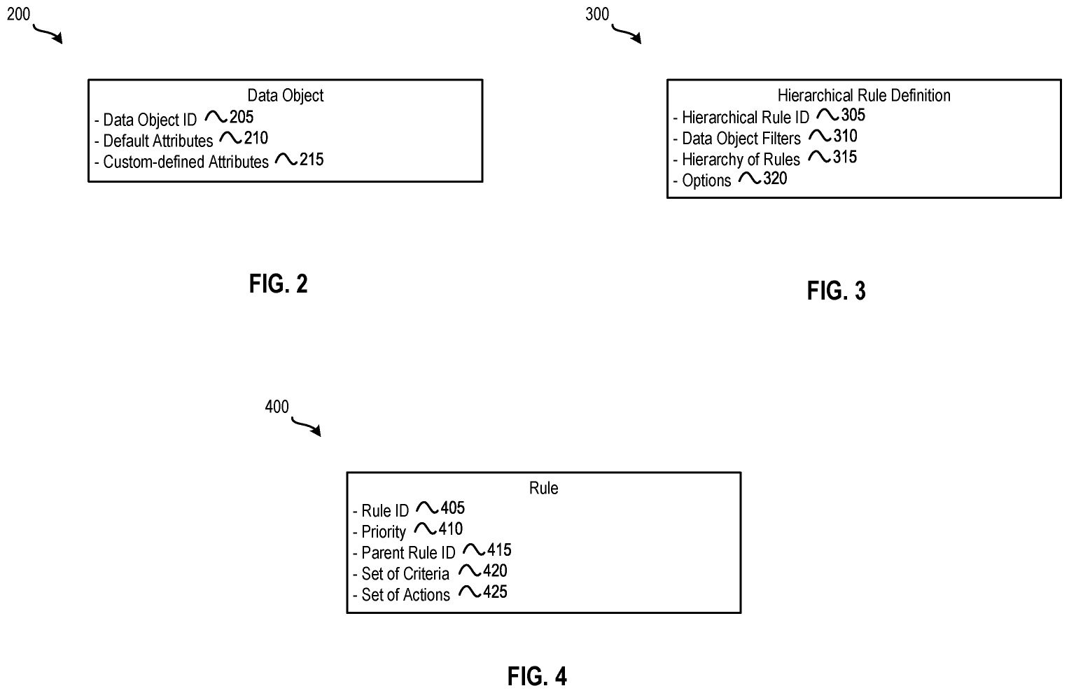

FIG. 2 illustrates an example data object 200 according to some embodiments. Specifically, FIG. 2 illustrates an example of the structure of data objects stored in data objects storage 130 and managed by data object manager 115. As shown, data object 200 includes data object identifier (ID) 205, default attributes 210, and custom-defined attributes 215. Data object ID 205 is a unique identifier for identifying a data object. Default attributes 210 are a set of default attributes. In some embodiments, default attributes 210 are included in each data object stored in data objects storage 130 and managed by data object manager 115. Examples of default attributes may include a data object ID for uniquely identifying a data object, a data object name, a description of the data object, a parent that specifies a parent data object of the data object, an effective start date that indicates a date on which the data object starts being valid, an effective end date that indicates a date on which the data object stops being valid, etc. Custom-defined attributes 215 are a set of attributes that may be defined for the data object (e.g., by a user of client device 105). Custom-defined attributes 215 can be unique to each data object. That is, different data objects can have different sets of custom-defined attributes 215.

Hierarchical rule manager 120 is responsible for managing hierarchical rules. For instance, hierarchical rule manager 120 can receive from client device 105 a hierarchical rule definition. Once hierarchical rule manager 120 receives it, hierarchical rule manager 120 stores the hierarchical rule definition in hierarchical rule definitions storage 135. In some cases, hierarchical rule manager 125 may receive from scheduler 125 a request to apply a set of hierarchical rules to data objects stored in data objects storage 130. In response to the request, hierarchical rule manager 120 accesses hierarchical rule definitions storage 135 and retrieves a set of hierarchical rule definitions associated with the set of hierarchical rules. Next, hierarchical rule manager 120 applies the set of hierarchical rules to the data objects stored in data objects storage 130. An example of how hierarchical rule manager 120 applies a hierarchical rule to data objects will be explained in detail below.

FIG. 3 illustrates an example hierarchical rule definition 300 according to some embodiments. As depicted, hierarchical rule definition 300 includes hierarchical rule ID 305, data object filters 310, hierarchy of rules 315, and options 320. Hierarchical rule ID 305 is a unique identifier for identifying hierarchical rule definition 300. Data object filters 310 is a set of data object filters for identifying data objects to which hierarchical rule definition 300 is to be applied. Each data object filter in the set of data object filters can specify an attribute of a data object, an operator (e.g., is equal to, is not equal to, is less than, is greater than, falls within a range of values, etc.), and a value for the attribute. Hierarchy of rules 315 includes a hierarchy of rules specified for hierarchical rule definition 300. Options 320 includes a set of options that can be enabled for hierarchical rule definition 300. Examples of such options include an apply to child data object option that propagates changes made to a particular data object to child data objects of the particular data object; a time lock option for locking a value for an attribute of a data object for a defined amount of a time or until a defined date; a versioning option for generating different versions of a particular data object when changes are made to the particular data object; a logging option for logging changes made to a particular data object; etc.

FIG. 4 illustrates an example rule 400 according to some embodiments. In some embodiments, rule 400 can be used to implement each rule in the hierarchy of rules of a hierarchical rule definition (e.g., hierarchical rule definition 300). As shown, rule 400 includes rule ID 405, priority 410, parent rule ID 415, set of criteria 420, and set of actions 425. Rule ID 405 is a unique identifier for identifying rule 400. Priority 410 indicates a priority in which rule 400 is to be evaluated with respect to other rules in the same level of the hierarchy. Parent rule ID 415 specifies a rule ID of a parent rule of rule 400. Set of criteria 420 includes a set of criteria for rule 400. Different types of criterion can be specified as a criterion in set of criteria 420. One type of criterion specifies a type of child rule evaluation. Another type of criterion specifies an attribute of a data object, an operator, and a value for the attribute. Other types of criterion may be possible. Set of actions 425 includes a set of actions for rule 400. Each action in set of actions 425 can specify an attribute of a data object and a value to which the attribute of the data object is to be set.

Scheduler 125 handles the scheduling of applying hierarchical rules to data objects. For example, scheduler 125 can receive from client device 105 a schedule for applying hierarchical rules to data objects. In response, scheduler 125 stores the schedule in schedule data storage 140. As another example, scheduler 125 may receive from client device 105 changes to a particular schedule. Once scheduler 125 receives the changes, scheduler 125 accesses schedule data storage 140 and modifies the particular schedule with the changes. Scheduler 125 is configured to continually check the schedules in schedule data storage 140 and determine when to apply hierarchical rules to data objects stored in data objects storage 130. Upon determining that a particular set of hierarchical rules are to be applied to data objects, scheduler 125 sends hierarchical rule manager 120 a request to do so.

An example operation will now be described by reference to FIGS. 1 and 5-13. Specifically, the example operation will demonstrate how a hierarchical rule is applied to data objects. For this example, a schedule stored in schedule data storage 140 specifies a hierarchical rule is to be applied to data objects stored in data objects storage 130 once a week on Monday at 12 AM. The operation starts at 12 AM on a Monday when scheduler 125 determines, based on the schedule stored in schedule data storage 140, that the hierarchical rule is to be applied to data objects stored in data objects storage 130. Thus, scheduler 125 sends hierarchical rule manager 120 a request to apply the hierarchical rule to data objects stored in data objects storage 130. In response to receiving the request, hierarchical rule manager 120 retrieves a hierarchical rule definition associated with the hierarchical rule. In this example, the hierarchical rule definition is structured in the same way as hierarchical rule definition 300. Thus, the hierarchical rule definition includes a hierarchical rule ID that unique identifies the hierarchical rule definition, a set of data object filters for identifying data objects to which the hierarchical rule definition is to be applied, a hierarchy of rules, and a set of options. Here, the data object filter includes a filter that specifies an attribute Z, an operation is equals to, and a value of 100 for the attribute Z. For this example, none of the options in the hierarchical rule definition are enabled.

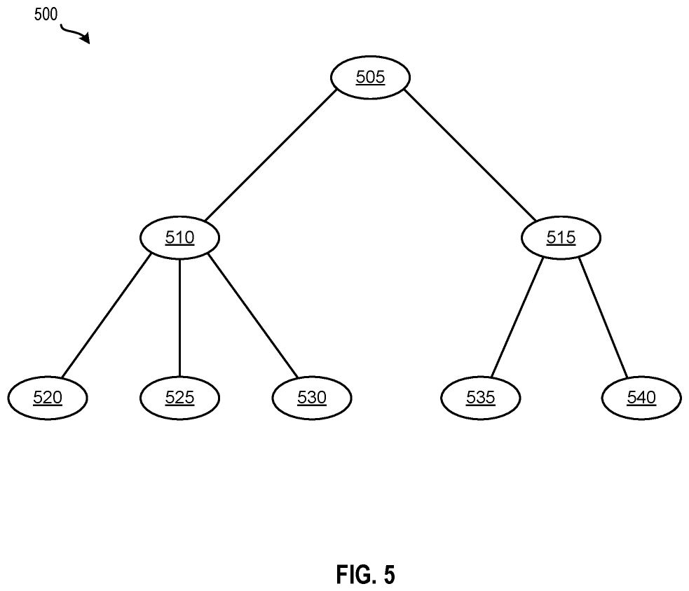

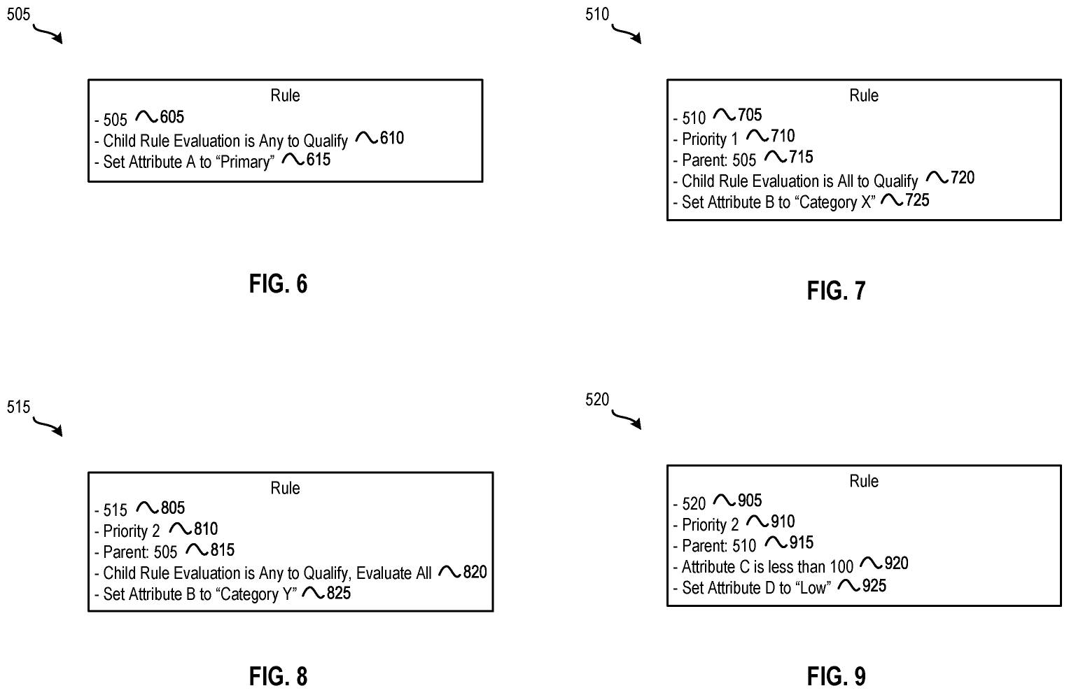

FIG. 5 illustrates an example hierarchy of rules 500 according to some embodiments. In particular, hierarchy of rules 500 is the hierarchy of rules specified in the hierarchical rule definition in this example. As illustrated, hierarchy of rules 500 includes rules 505-540. Rule 505 has two child rules 510 and 515. Rule 510 has three child rules 520-530. Rule 515 has two child rules 535 and 540. FIG. 6 illustrates rule 505 in hierarchy of rules 500. As depicted, rule 505 includes rule ID 605, set of criteria 610, and set of actions 615. For all the example rules used in the example operation, the reference number of the rule will be used as the rule ID of the rule for the purpose of simplicity. Here, set of criteria 610 specifies a type of child rule evaluation: any to qualify. This type of child rule evaluation indicates that the corresponding set of actions of a rule are to be performed when one of the child rules is evaluated as true. Any remaining child rules are not evaluated. For this example, set of actions 615 are to be performed on a data object when one of the child rules of rule 505 is evaluated as true (i.e., the data object satisfies the set of criteria specified in one of the child rules of rule 505) for the data object. Set of actions 615 specifies to set an attribute A of a data object to the value “Primary”.

FIG. 7 illustrates rule 510 in hierarchy of rules 500. As illustrated in FIG. 7, rule 510 includes rule ID 705, priority 710, parent rule ID 715, set of criteria 720, and set of actions 725. Rule ID 705 is 510. Priority 710 is 1, which represents the highest priority in this example. Therefore, rule 510 will be the first rule evaluated between rules 510 and 515. Parent rule ID 715 specifies rule 505 as the parent rule of rule 510. Set of criteria 720 specifies a type of child rule evaluation: all to qualify. An all to qualify type of child rule evaluation indicates that the corresponding set of actions of a rule are to be performed only when each and every child rule is evaluated as true. Here, set of actions 725 are to be performed on a data object only if each and every child rule of rule 510 is evaluated as true (i.e., the data object satisfies the set of criteria specified in each of the child rules of rule 510) for the data object. Set of actions 725 specifies to set an attribute B of a data object to the value “Category X”.

FIG. 8 illustrates rule 515 in hierarchy of rules 500. As shown, rule 515 includes rule ID 805, priority 810, parent rule ID 815, set of criteria 820, and set of actions 825. Rule ID 805 is 515. Priority 810 is 2, which represents the second highest priority for this example. As such, rule 515 will be the second rule evaluated between rules 510 and 515. Parent rule ID 815 specifies rule 505 as the parent rule of rule 515. Set of criteria 820 specifies a type of child rule evaluation: any to qualify, evaluate all. An any to qualify, evaluate all type of child rule evaluation indicates that the corresponding set of actions of a rule are to be performed when one of the child rules is evaluated as true. Any remaining child rules are also evaluated. In this example, set of actions 825 are to be performed on a data object when one of the child rules of rule 515 is evaluated as true (i.e., the data object satisfies the set of criteria specified in one of the child rules of rule 515) for the data object. Set of actions 825 specifies to set an attribute B of a data object to the value “Category Y”.

FIG. 9 illustrates rule 520 in hierarchy of rules 500. As depicted in FIG. 9, rule 520 includes rule ID 905, priority 910, parent rule ID 915, set of criteria 920, and set of actions 925. Rule ID 905 is 520. Priority 910 is 2, which represents the second highest priority for this example. Accordingly, rule 520 will be the second rule evaluated between rules 520-530. Parent rule ID 915 specifies rule 510 as the parent rule of rule 520. Set of criteria 920 specifies an attribute C of a data object, an operator “is less than,” and a value of 100 for the attribute. Set of actions 915 are to be performed if the value for the attribute C of a data object is less than 100. Set of actions 925 specifies to set an attribute D of a data object to the value “Low”.

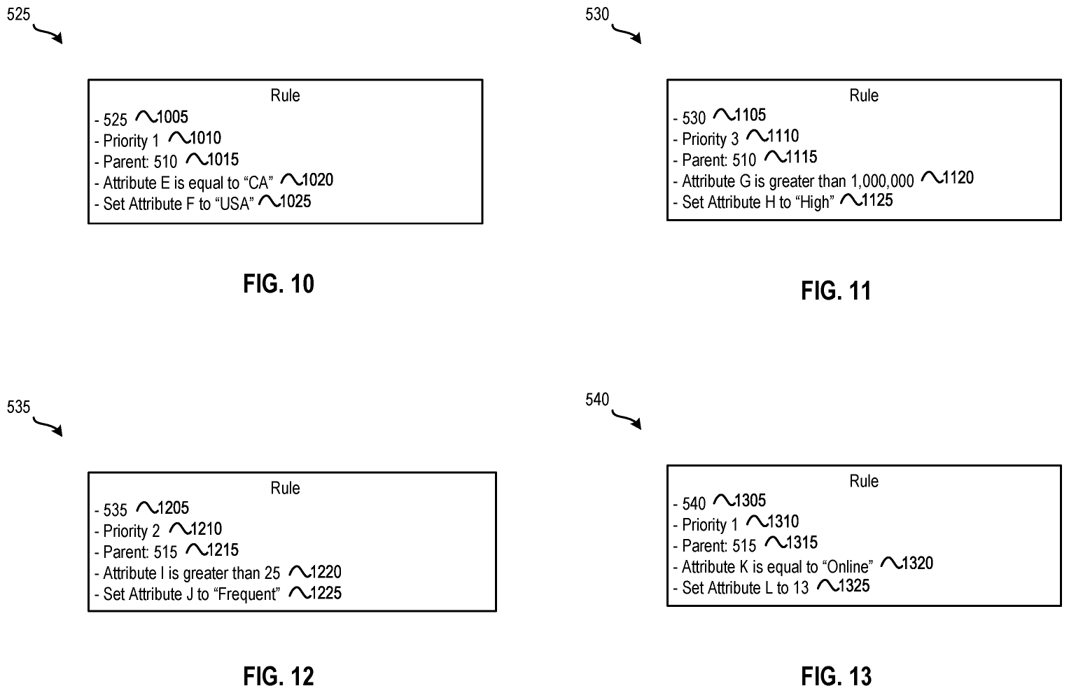

FIG. 10 illustrates rule 525 in hierarchy of rules 500. As shown, rule 525 includes rule ID 1005, priority 1010, parent rule ID 1015, set of criteria 1020, and set of actions 1025. Rule ID 1005 is 525. Priority 1010 is 1, which represents the highest priority in this example. Hence, rule 525 will be the first rule evaluated between rules 520-530. Parent rule ID 1015 specifies rule 510 as the parent rule of rule 525. Set of criteria 1020 specifies an attribute E of a data object, an operator “is equal to,” and a value of “CA” for the attribute. Set of actions 1015 are to be performed if the value for the attribute E of a data object is equal to “CA.” Set of actions 1025 specifies to set an attribute F of a data object to the value “USA”.

FIG. 11 illustrates rule 530 in hierarchy of rules 500. As illustrated, rule 530 includes rule ID 1105, priority 1110, parent rule ID 1115, set of criteria 1120, and set of actions 1125. Rule ID 1105 is 530. Priority 1110 is 3, which represents the third highest priority for this example. Thus, rule 530 will be the third rule evaluated between rules 520-530. Parent rule ID 1115 specifies rule 510 as the parent rule of rule 530. Set of criteria 1120 specifies an attribute G of a data object, an operator “is greater than,” and a value of 1,000,000 for the attribute. Set of actions 1115 are to be performed if the value for the attribute G of a data object is greater than 1,000,000. Set of actions 1125 specifies to set an attribute H of a data object to the value “High.”

FIG. 12 illustrates rule 535 in hierarchy of rules 500. As depicted, rule 535 includes rule ID 1205, priority 1210, parent rule ID 1215, set of criteria 1220, and set of actions 1225. Rule ID 1205 is 535. Priority 1210 is 2, which represents the second highest priority for this example. As such, rule 535 will be the second rule evaluated between rules 535 and 540. Parent rule ID 1215 specifies rule 515 as the parent rule of rule 535. Set of criteria 1220 specifies an attribute I of a data object, an operator “is greater than,” and a value of 25 for the attribute. Set of actions 1215 are to be performed if the value for the attribute I of a data object is greater than 25. Set of actions 1225 specifies to set an attribute J of a data object to the value “Frequent.”

FIG. 13 illustrates rule 540 in hierarchy of rules 500. As illustrated in FIG. 13, rule 540 includes rule ID 1305, priority 1310, parent rule ID 1315, set of criteria 1320, and set of actions 1325. Rule ID 1305 is 540. Priority 1310 is 1, which represents the highest priority for this example. Therefore, rule 540 will be the first rule evaluated between rules 535 and 540. Parent rule ID 1315 specifies rule 515 as the parent rule of rule 540. Set of criteria 1320 specifies an attribute K of a data object, an operator “is equal to,” and a value of “Online” for the attribute. Set of actions 1315 are to be performed if the value for the attribute K of a data object is equal to “Online.” Set of actions 1325 specifies to set an attribute L of a data object to the value 13.

Returning to the example operation, after hierarchical rule manager 120 retrieves the hierarchical rule definition associated with the hierarchical rule, hierarchical rule manager 120 accesses data objects storage 130 and uses the data object filter specified in the hierarchical rule definition to retrieve data objects that have a value of 100 for the attribute Z. Next, hierarchical rule manager 120 selects a data object from the retrieved data objects to apply the hierarchical rule definition. Hierarchical rule manager 120 applies the hierarchical rule definition to the selected data object by starting at the root rule in hierarchy of rules 500, which is rule 505. Since set of criteria 610 of rule 505 specifies an any to qualify type of child rule evaluation, hierarchical rule manager 120 proceeds to evaluate the child rules of rule 505.

Based on the priorities of rules 510 and 515, hierarchy rule manager 120 determines to evaluate rule 510 next as it has the higher priority of 1. As such, hierarchical rule manager 120 traverses hierarchy of rules 500 from rule 505 to rule 510. Set of criteria 720 specifies an all to qualify type of child rule evaluation so hierarchical rule manager 120 proceeds to evaluate the child rules of rule 510. Based on the priorities of rules 520-530, hierarchical rule manager 120 determines to evaluate rule 525 next because it has the highest priority of 1. Accordingly, hierarchical rule manager 120 traverses hierarchy of rules 500 from rule 510 to rule 525. Set of criteria 1020 specifies a criterion of the value for the attribute E of a data object is equal to “CA.” Hence, hierarchical rule manager 120 checks the value for attribute E of the data object. In this example, the attribute E of the data object is “CA.” Since the data object satisfies set of criteria 1020, hierarchical rule manager 120 performs set of actions 1025 and sets the attribute F of the data object to “USA.” Then, hierarchical rule manager 120 proceeds to evaluate the next child rule of rule 510.

According to the priorities of the remaining child rules 520 and 530, hierarchical rule manager 120 determines to evaluate rule 520 next since it has the second highest priority of 2. Then, hierarchical rule manager 120 traverse hierarchy of rules 500 from rule 525 to rule 520. Set of criteria 920 specifies a criterion of the value for the attribute C of a data object is less than 100. Next, hierarchical rule manager 120 checks the value for the attribute C of the data object. For this example, the attribute C of the data object is 178. Because the data object does not satisfy set of criteria 920, hierarchical rule manager 120 determines that the data object does not satisfy set of criteria 720. Thus, hierarchical rule manager 120 does not evaluate any of the remaining child rules of rule 510 (rule 530 in this example). Instead, hierarchical rule manager 120 proceeds to the next child rule of rule 505.

Next, hierarchical rule manager 120 traverses hierarchy of rules 500 from rule 520 to rule 515. Set of criteria 820 specifies an any to qualify, evaluate all, type of child rule evaluation. As such, hierarchical rule manager 120 proceeds to evaluate the child rules of rule 515. Based on the priorities of rules 535 and 540, hierarchical rule manager 120 determines to evaluate rule 540 next because it has the highest priority of 1. So hierarchical rule manager 120 traverses hierarchy of rules 500 from rule 515 to rule 540. Set of criteria 1320 specifies a criterion of the value for the attribute K of a data object is equal to “Online.” Hierarchical rule manager 120 checks the value for attribute K of the data object. Here, the attribute K of the data object is “Online.” As the data object satisfies set of criteria 1320, hierarchical rule manager 120 performs set of actions 1325 and sets the attribute L of the data object to 13. As a result of satisfying set of criteria 1320, the data object satisfies set of criteria 820 and, in turn, satisfies set of criteria 610. So hierarchical rule manager 120 performs set of action 825 and sets attribute B of the data object to “Category Y.” In addition, hierarchical rule manager 120 performs set of actions 615 and sets attribute A of the data object to “Primary.”

Even though the data object satisfies set of criteria 1320, thereby satisfying set of criteria 820, hierarchical rule manager 120 continues to evaluate any remaining child rules of rule 515 because the type of child rule evaluation specified in rule 515 is any to qualify, evaluate all. Rule 535 has the second highest priority among the child rules of rule 515 so hierarchical rule manager 120 then traverses hierarchy of rules 500 from rule 540 to rule 535. Set of criteria 1220 specifies the value for the attribute I of a data object is greater than 25. Next, hierarchical rule manager 120 checks the value for attribute I of the data object. In this example, the attribute I of the data object is 78. Because the data object satisfies set of criteria 1220, hierarchical rule manager 120 performs set of actions 1225 and sets the attribute J of the data object to “Frequent.” Hierarchical rule manager 120 has finished traversing hierarchy of rules 500 and, thus, processing of the data object is finished. Hierarchical rule manager 120 proceeds to apply the hierarchical rule definition to each of the remaining data objects retrieved from data objects storage 130 in the same manner described above.

As mentioned above, a hierarchical rule definition can include a set of options that can be enabled along with several examples of such options. For instance, an apply to child data object option, when enabled, propagates changes made to a particular data object to child data objects of the particular data object. Referring to the example operation above, if the apply to child data object option is enabled, after applying the hierarchical rule definition to a data object, hierarchical rule manager 120 would determine the child data objects of the data object based on the parent attribute of the data objects mentioned above. Then, hierarchical rule manager 120 would set the same values to the same attributes of the child data objects as those set for the data object. Another option is a time lock option where a value for an attribute of a data object is locked for a defined amount of a time or until a defined date. When the time lock option is enabled and the attributed associated with the time lock is to be modified based on a set of actions specified in a rule, hierarchical rule manager 120 would check whether the time lock is still active. If the time lock option specifies a defined amount of time, hierarchical rule manager 120 checks whether the defined amount of time has run out. If the time lock option specifies a date, hierarchical rule manager 120 checks whether the current date has passed the specified date.

In some embodiments, an exception to a timelock option may be configured in the form of a threshold. For instance, if the time lock is still active, hierarchical rule manager 120 checks whether the value of the attribute associated with the time lock passes the threshold value, then hierarchical rule manager 120 determines to override the time lock option and modify the attribute according to the set of actions specified in the rule. Otherwise, the time lock option is still valid and, thus, hierarchical rule manager 120 does not modify the attribute.

A versioning option is another option that can be enabled for a hierarchical rule definition. When this option is enabled, hierarchical rule manager 120 would set the effective end data of the data object to the current data, generate a copy of the data object, and set the effective start date of the generated data object to the current date. Then, hierarchical rule manager 120 can apply the hierarchical rule definition to the generated copy of the data object. Yet another example is a logging option that logs changes made to a particular data object. When the logging option is enabled, while applying a hierarchical rule definition to a data object, hierarchical rule manager 120 generates a log entry for every rule where the data object satisfies the set of criteria of the rule. Hierarchical rule manager 120 stores the log entries in the data object once hierarchical rule manager 120 finishes applying the hierarchical rule definition to the data object. As such, the logging option can serve as an auditing function by providing information related to which rules were satisfied for a specific data object that resulted in updates to attributes of the data object.

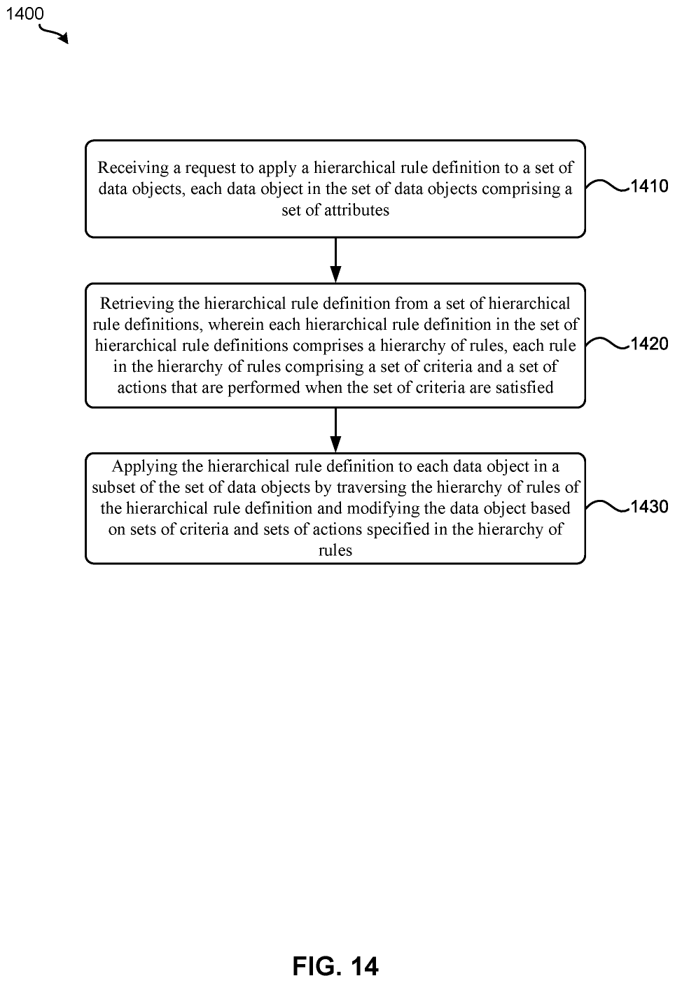

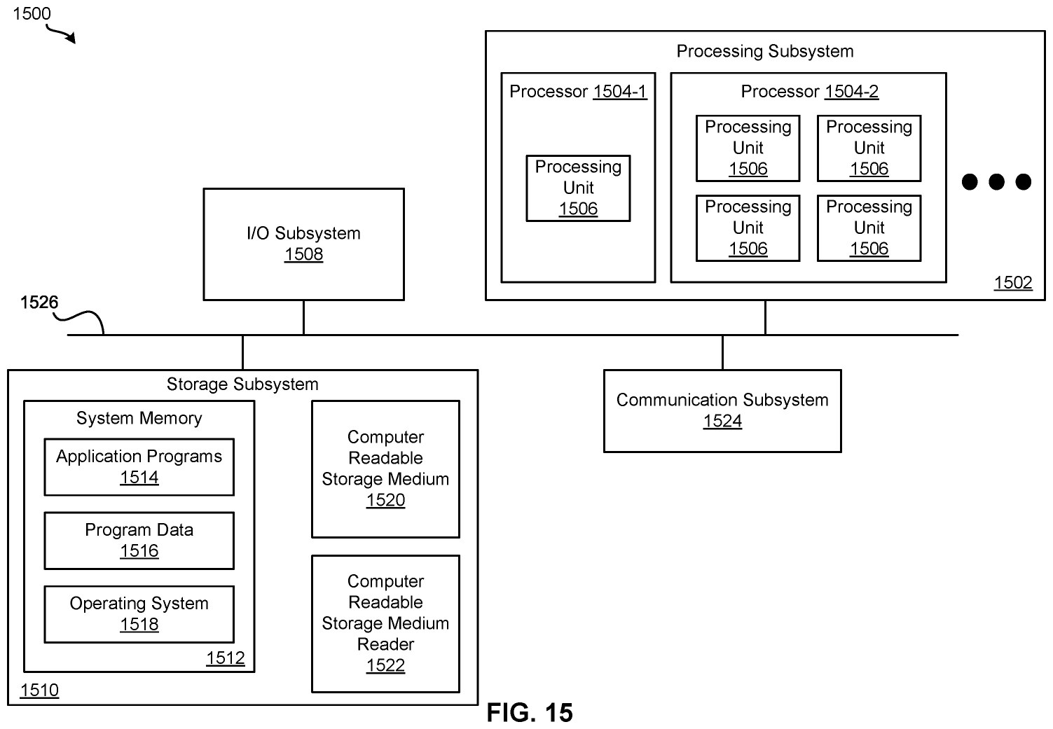

FIG. 14 illustrates a process 1400 for determining data object attributes based on hierarchical rules according to some embodiments. In some embodiments, computing system 110 performs process 1400. Process 1400 begins by receiving, at 1410, a request to apply a hierarchical rule definition to a set of data objects, each data object in the set of data objects comprising a set of attributes. Referring to FIG. 1, hierarchical rule manager 120 may receive from scheduler 125 a request to apply a hierarchical rule to data objects stored in data objects storage 130.

Next, process 1400 retrieves, at 1420, the hierarchical rule definition from a set of hierarchical rule definitions. Each hierarchical rule definition in the set of hierarchical rule definitions comprises a hierarchy of rules. Each rule in the hierarchy of rules comprises a set of criteria and a set of actions that are performed when the set of criteria are satisfied. Referring to FIGS. 1 and 5 as an example, hierarchical rule manager 120 can retrieve a hierarchical rule definition from hierarchical rule definitions storage 135. The hierarchical rule definition can include a hierarchy of rules, such as hierarchy of rules 500.

Finally, process 1400 applies, at 1430, the hierarchical rule definition to each data object in a subset of the set of data objects by traversing the hierarchy of rules of the hierarchical rule definition and modifying the data object based on sets of criteria and sets of actions specified in the hierarchy of rules. Referring to FIGS. 1 and 5 as an example, hierarchical rule manager 120 may apply a hierarchical rule definition that includes hierarchy of rules 500 to a data object by traversing rules 505-540 in hierarchy of rules 500 in the same or similar manner as that described above by reference to the example operation.

FIG. 15 illustrates an exemplary computer system 1500 for implementing various embodiments described above. For example, computer system 1500 may be used to implement systems client device 105 and computing system 110. Computer system 1500 may be a desktop computer, a laptop, a server computer, or any other type of computer system or combination thereof. Some or all elements of data object manager 115, hierarchical rule manager 120, scheduler 125, or combinations thereof can be included or implemented in computer system 1500. In addition, computer system 1500 can implement many of the operations, methods, and/or processes described above (e.g., process 1400). As shown in FIG. 15, computer system 1500 includes processing subsystem 1502, which communicates, via bus subsystem 1526, with input/output (I/O) subsystem 1508, storage subsystem 1510 and communication subsystem 1524.

Bus subsystem 1526 is configured to facilitate communication among the various components and subsystems of computer system 1500. While bus subsystem 1526 is illustrated in FIG. 15 as a single bus, one of ordinary skill in the art will understand that bus subsystem 1526 may be implemented as multiple buses. Bus subsystem 1526 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 1502, which can be implemented as one or more integrated circuits (e.g., a conventional microprocessor or microcontroller), controls the operation of computer system 1500. Processing subsystem 1502 may include one or more processors 1504. Each processor 1504 may include one processing unit 1506 (e.g., a single core processor such as processor 1504-1) or several processing units 1506 (e.g., a multicore processor such as processor 1504-2). In some embodiments, processors 1504 of processing subsystem 1502 may be implemented as independent processors while, in other embodiments, processors 1504 of processing subsystem 1502 may be implemented as multiple processors integrate into a single chip or multiple chips. Still, in some embodiments, processors 1504 of processing subsystem 1502 may be implemented as a combination of independent processors and multiple processors integrated into a single chip or multiple chips.

In some embodiments, processing subsystem 1502 can execute a variety of programs or processes in response to program code and can maintain multiple concurrently executing programs or processes. At any given time, some or all of the program code to be executed can reside in processing subsystem 1502 and/or in storage subsystem 1510. Through suitable programming, processing subsystem 1502 can provide various functionalities, such as the functionalities described above by reference to process 1400.

I/O subsystem 1508 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1500 to a user or another device (e.g., a printer).

As illustrated in FIG. 15, storage subsystem 1510 includes system memory 1512, computer-readable storage medium 1520, and computer-readable storage medium reader 1522. System memory 1512 may be configured to store software in the form of program instructions that are loadable and executable by processing subsystem 1502 as well as data generated during the execution of program instructions. In some embodiments, system memory 1512 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1512 may include different types of memory, such as static random access memory (SRAM) and/or dynamic random access memory (DRAM). System memory 1512 may include a basic input/output system (BIOS), in some embodiments, that is configured to store basic routines to facilitate transferring information between elements within computer system 1500 (e.g., during start-up). Such a BIOS may be stored in ROM (e.g., a ROM chip), flash memory, or any other type of memory that may be configured to store the BIOS.

As shown in FIG. 15, system memory 1512 includes application programs 1514, program data 1516, and operating system (OS) 1518. OS 1518 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 1520 may be a non-transitory computer-readable medium configured to store software (e.g., programs, code modules, data constructs, instructions, etc.). Many of the components (e.g., data object manager 115, hierarchical rule manager 120, and scheduler 125) and/or processes (e.g., process 1400) described above may be implemented as software that when executed by a processor or processing unit (e.g., a processor or processing unit of processing subsystem 1502) performs the operations of such components and/or processes. Storage subsystem 1510 may also store data used for, or generated during, the execution of the software.

Storage subsystem 1510 may also include computer-readable storage medium reader 1522 that is configured to communicate with computer-readable storage medium 1520. Together and, optionally, in combination with system memory 1512, computer-readable storage medium 1520 may comprehensively represent remote, local, fixed, and/or removable storage devices plus storage media for temporarily and/or more permanently containing, storing, transmitting, and retrieving computer-readable information.

Computer-readable storage medium 1520 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 1524 serves as an interface for receiving data from, and transmitting data to, other devices, computer systems, and networks. For example, communication subsystem 1524 may allow computer system 1500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1524 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1524 may provide components configured for wired communication (e.g., Ethernet) in addition to or instead of components configured for wireless communication.

One of ordinary skill in the art will realize that the architecture shown in FIG. 15 is only an example architecture of computer system 1500, and that computer system 1500 may have additional or fewer components than shown, or a different configuration of components. The various components shown in FIG. 15 may be implemented in hardware, software, firmware or any combination thereof, including one or more signal processing and/or application specific integrated circuits.

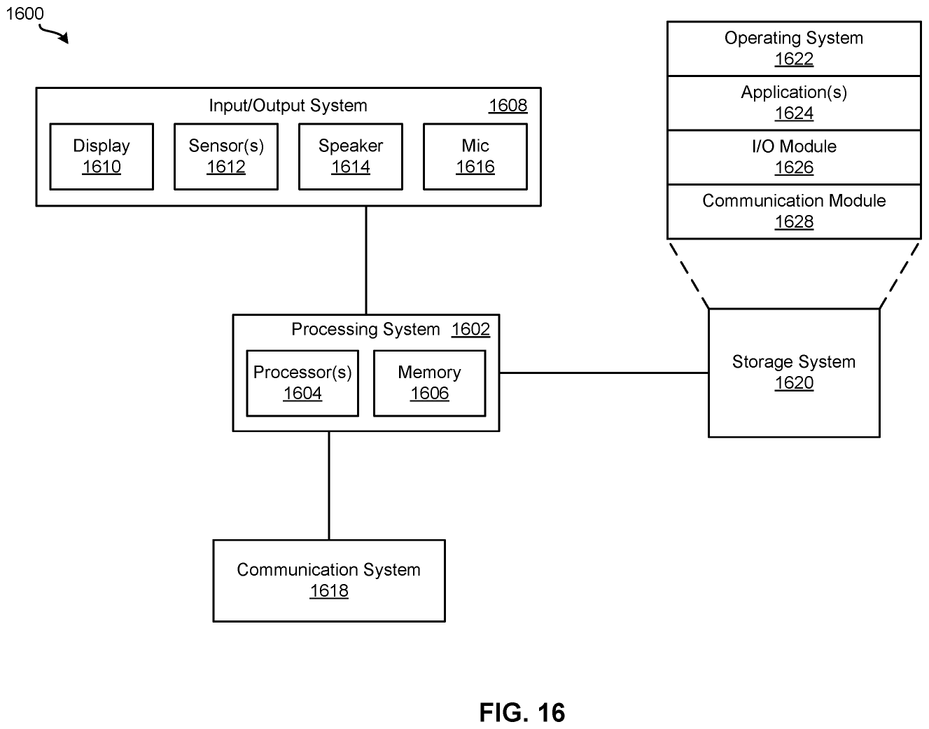

FIG. 16 illustrates an exemplary computing device 1600 for implementing various embodiments described above. For example, computing device 1600 may be used to implement devices client device 105. Computing device 1600 may be a cellphone, a smartphone, a wearable device, an activity tracker or manager, a tablet, a personal digital assistant (PDA), a media player, or any other type of mobile computing device or combination thereof. As shown in FIG. 16, computing device 1600 includes processing system 1602, input/output (I/O) system 1608, communication system 1618, and storage system 1620. These components may be coupled by one or more communication buses or signal lines.

Processing system 1602, which can be implemented as one or more integrated circuits (e.g., a conventional microprocessor or microcontroller), controls the operation of computing device 1600. As shown, processing system 1602 includes one or more processors 1604 and memory 1606. Processors 1604 are configured to run or execute various software and/or sets of instructions stored in memory 1606 to perform various functions for computing device 1600 and to process data.

Each processor of processors 1604 may include one processing unit (e.g., a single core processor) or several processing units (e.g., a multicore processor). In some embodiments, processors 1604 of processing system 1602 may be implemented as independent processors while, in other embodiments, processors 1604 of processing system 1602 may be implemented as multiple processors integrate into a single chip. Still, in some embodiments, processors 1604 of processing system 1602 may be implemented as a combination of independent processors and multiple processors integrated into a single chip.

Memory 1606 may be configured to receive and store software (e.g., operating system 1622, applications 1624, I/O module 1626, communication module 1628, etc. from storage system 1620) in the form of program instructions that are loadable and executable by processors 1604 as well as data generated during the execution of program instructions. In some embodiments, memory 1606 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1608 is responsible for receiving input through various components and providing output through various components. As shown for this example, I/O system 1608 includes display 1610, one or more sensors 1612, speaker 1614, and microphone 1616. Display 1610 is configured to output visual information (e.g., a graphical user interface (GUI) generated and/or rendered by processors 1604). In some embodiments, display 1610 is a touch screen that is configured to also receive touch-based input. Display 1610 may be implemented using liquid crystal display (LCD) technology, light-emitting diode (LED) technology, organic LED (OLED) technology, organic electro luminescence (OEL) technology, or any other type of display technologies. Sensors 1612 may include any number of different types of sensors for measuring a physical quantity (e.g., temperature, force, pressure, acceleration, orientation, light, radiation, etc.). Speaker 1614 is configured to output audio information and microphone 1616 is configured to receive audio input. One of ordinary skill in the art will appreciate that I/O system 1608 may include any number of additional, fewer, and/or different components. For instance, I/O system 1608 may include a keypad or keyboard for receiving input, a port for transmitting data, receiving data and/or power, and/or communicating with another device or component, an image capture component for capturing photos and/or videos, etc.

Communication system 1618 serves as an interface for receiving data from, and transmitting data to, other devices, computer systems, and networks. For example, communication system 1618 may allow computing device 1600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1618 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1618 may provide components configured for wired communication (e.g., Ethernet) in addition to or instead of components configured for wireless communication.

Storage system 1620 handles the storage and management of data for computing device 1600. Storage system 1620 may be implemented by one or more non-transitory machine-readable mediums that are configured to store software (e.g., programs, code modules, data constructs, instructions, etc.) and store data used for, or generated during, the execution of the software.

In this example, storage system 1620 includes operating system 1622, one or more applications 1624, I/O module 1626, and communication module 1628. Operating system 1622 includes various procedures, sets of instructions, software components and/or drivers for controlling and managing general system tasks (e.g., memory management, storage device control, power management, etc.) and facilitates communication between various hardware and software components. Operating system 1622 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1624 can include any number of different applications installed on computing device 1600. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1626 manages information received via input components (e.g., display 1610, sensors 1612, and microphone 1616) and information to be outputted via output components (e.g., display 1610 and speaker 1614). Communication module 1628 facilitates communication with other devices via communication system 1618 and includes various software components for handling data received from communication system 1618.

One of ordinary skill in the art will realize that the architecture shown in FIG. 16 is only an example architecture of computing device 1600, and that computing device 1600 may have additional or fewer components than shown, or a different configuration of components. The various components shown in FIG. 16 may be implemented in hardware, software, firmware or any combination thereof, including one or more signal processing and/or application specific integrated circuits.

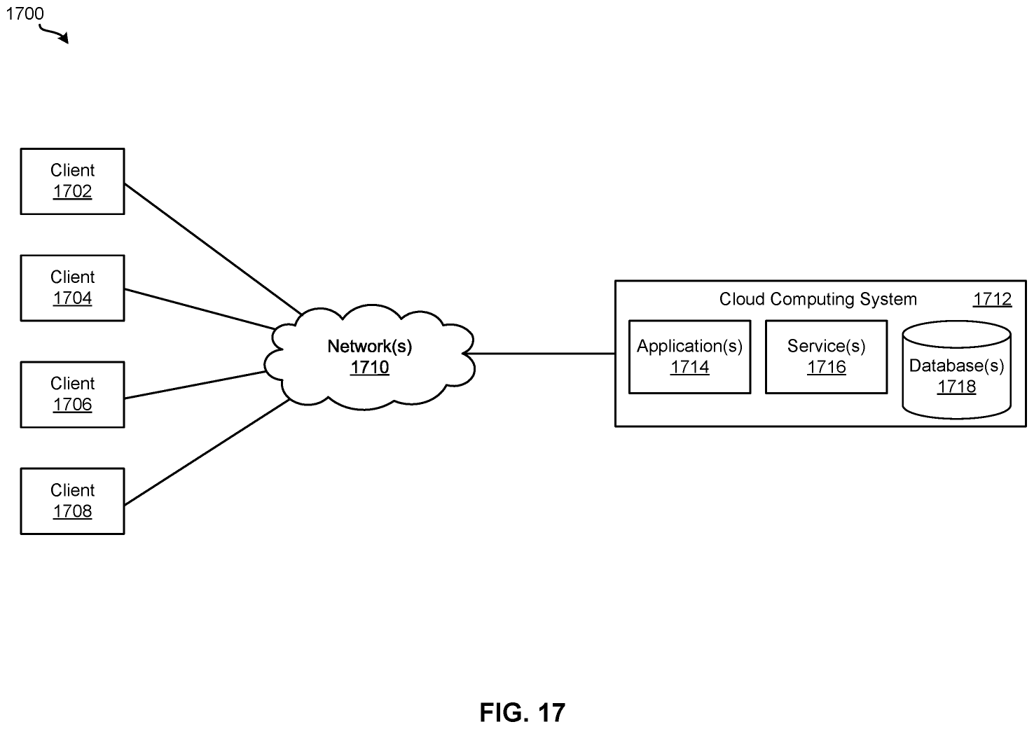

FIG. 17 illustrates an exemplary system 1700 for implementing various embodiments described above. For example, one of the client devices 1702-1708 may be used to implement client device 105 and cloud computing system 1712 may be used to implement computing system 110. As shown, system 1700 includes client devices 1702-1708, one or more networks 1710, and cloud computing system 1712. Cloud computing system 1712 is configured to provide resources and data to client devices 1702-1708 via networks 1710. In some embodiments, cloud computing system 1700 provides resources to any number of different users (e.g., customers, tenants, organizations, etc.). Cloud computing system 1712 may be implemented by one or more computer systems (e.g., servers), virtual machines operating on a computer system, or a combination thereof.

As shown, cloud computing system 1712 includes one or more applications 1714, one or more services 1716, and one or more databases 1718. Cloud computing system 1700 may provide applications 1714, services 1716, and databases 1718 to any number of different customers in a self-service, subscription-based, elastically scalable, reliable, highly available, and secure manner.

In some embodiments, cloud computing system 1700 may be adapted to automatically provision, manage, and track a customer's subscriptions to services offered by cloud computing system 1700. Cloud computing system 1700 may provide cloud services via different deployment models. For example, cloud services may be provided under a public cloud model in which cloud computing system 1700 is owned by an organization selling cloud services and the cloud services are made available to the general public or different industry enterprises. As another example, cloud services may be provided under a private cloud model in which cloud computing system 1700 is operated solely for a single organization and may provide cloud services for one or more entities within the organization. The cloud services may also be provided under a community cloud model in which cloud computing system 1700 and the cloud services provided by cloud computing system 1700 are shared by several organizations in a related community. The cloud services may also be provided under a hybrid cloud model, which is a combination of two or more of the aforementioned different models.

In some instances, any one of applications 1714, services 1716, and databases 1718 made available to client devices 1702-1708 via networks 1710 from cloud computing system 1712 is referred to as a “cloud service.” Typically, servers and systems that make up cloud computing system 1712 are different from the on-premises servers and systems of a customer. For example, cloud computing system 1712 may host an application and a user of one of client devices 1702-1708 may order and use the application via networks 1710.

Applications 1714 may include software applications that are configured to execute on cloud computing system 1712 (e.g., a computer system or a virtual machine operating on a computer system) and be accessed, controlled, managed, etc. via client devices 1702-1708. In some embodiments, applications 1714 may include server applications and/or mid-tier applications (e.g., HTTP (hypertext transport protocol) server applications, FTP (file transfer protocol) server applications, CGI (common gateway interface) server applications, JAVA server applications, etc.). Services 1716 are software components, modules, application, etc. that are configured to execute on cloud computing system 1712 and provide functionalities to client devices 1702-1708 via networks 1710. Services 1716 may be web-based services or on-demand cloud services.

Databases 1718 are configured to store and/or manage data that is accessed by applications 1714, services 1716, and/or client devices 1702-1708. For instance, storages 130-140 may be stored in databases 1718. Databases 1718 may reside on a non-transitory storage medium local to (and/or resident in) cloud computing system 1712, in a storage-area network (SAN), on a non-transitory storage medium local located remotely from cloud computing system 1712. In some embodiments, databases 1718 may include relational databases that are managed by a relational database management system (RDBMS). Databases 1718 may be a column-oriented databases, row-oriented databases, or a combination thereof. In some embodiments, some or all of databases 1718 are in-memory databases. That is, in some such embodiments, data for databases 1718 are stored and managed in memory (e.g., random access memory (RAM)).

Client devices 1702-1708 are configured to execute and operate a client application (e.g., a web browser, a proprietary client application, etc.) that communicates with applications 1714, services 1716, and/or databases 1718 via networks 1710. This way, client devices 1702-1708 may access the various functionalities provided by applications 1714, services 1716, and databases 1718 while applications 1714, services 1716, and databases 1718 are operating (e.g., hosted) on cloud computing system 1700. Client devices 1702-1708 may be computer system 1500 or computing device 1600, as described above by reference to FIGS. 15 and 16, respectively. Although system 1700 is shown with four client devices, any number of client devices may be supported.

Networks 1710 may be any type of network configured to facilitate data communications among client devices 1702-1708 and cloud computing system 1712 using any of a variety of network protocols. Networks 1710 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving a request to apply a hierarchical rule definition to a set of data objects, each data object in the set of data objects comprising a set of attributes;
retrieving the hierarchical rule definition from a set of hierarchical rule definitions, wherein each hierarchical rule definition in the set of hierarchical rule definitions comprises a hierarchy of rules, each rule in the hierarchy of rules comprising a set of criteria and a set of actions that are performed when the set of criteria are satisfied; and
applying the hierarchical rule definition to each data object in a subset of the set of data objects by traversing the hierarchy of rules of the hierarchical rule definition and modifying the data object based on sets of criteria and sets of actions specified in the hierarchy of rules.

2. The non-transitory machine-readable medium of claim 1, wherein the set of criteria of a particular rule in the hierarchy of rules comprises a child rule evaluation type, wherein the set of actions of the particular rule in the hierarchy of rules comprises setting a specified value for a particular attribute in the set of attributes.

3. The non-transitory machine-readable medium of claim 2, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
evaluating at least one child rule of the particular rule in the hierarchy of rules on the data object; and
based on the evaluation, setting a value of the particular attribute of the data object to the specified value.

4. The non-transitory machine-readable medium of claim 1, wherein the set of criteria of a particular rule in the hierarchy of rules comprises a first value for a first attribute in the set of attributes satisfies a condition, wherein the set of actions of the particular rule in the hierarchy of rules comprises setting a second value for a second attribute in the set of attributes.

5. The non-transitory machine-readable medium of claim 4, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
determining whether the first value for the first attribute of the data object satisfies the condition; and
based on the determination, setting a value of the second attribute of the data object to the second value.

6. The non-transitory machine-readable medium of claim 1, wherein each hierarchical rule definition in the set of hierarchical rule definitions further comprises a set of data object filters, wherein the program further comprises a set of instructions for applying the set of data object filters on the set of data objects to determine the subset of the set of data objects.

7. The non-transitory machine-readable medium of claim 1, wherein the hierarchical rule definition further comprises an apply to child data object option, wherein the set of attributes comprises a parent data object identifier (ID), wherein, when the apply to child data object option is enabled, applying the hierarchical rule definition to each data object in the subset of the set of data objects is further by determining a set of child data objects of the data object based on the parent data object IDs of the set of data objects and modifying each data object in the set of child data objects in the same manner as the modification of the data object.

8. A method comprising:
receiving a request to apply a hierarchical rule definition to a set of data objects, each data object in the set of data objects comprising a set of attributes;
retrieving the hierarchical rule definition from a set of hierarchical rule definitions, wherein each hierarchical rule definition in the set of hierarchical rule definitions comprises a hierarchy of rules, each rule in the hierarchy of rules comprising a set of criteria and a set of actions that are performed when the set of criteria are satisfied; and
applying the hierarchical rule definition to each data object in a subset of the set of data objects by traversing the hierarchy of rules of the hierarchical rule definition and modifying the data object based on sets of criteria and sets of actions specified in the hierarchy of rules.

9. The method of claim 8, wherein the set of criteria of a particular rule in the hierarchy of rules comprises a child rule evaluation type, wherein the set of actions of the particular rule in the hierarchy of rules comprises setting a specified value for a particular attribute in the set of attributes.

10. The method of claim 9, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
evaluating at least one child rule of the particular rule in the hierarchy of rules on the data object; and
based on the evaluation, setting a value of the particular attribute of the data object to the specified value.

11. The method of claim 8, wherein the set of criteria of a particular rule in the hierarchy of rules comprises a first value for a first attribute in the set of attributes satisfies a condition, wherein the set of actions of the particular rule in the hierarchy of rules comprises setting a second value for a second attribute in the set of attributes.

12. The method of claim 11, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
determining whether the first value for the first attribute of the data object satisfies the condition; and
based on the determination, setting a value of the second attribute of the data object to the second value.

13. The method of claim 8, wherein each hierarchical rule definition in the set of hierarchical rule definitions further comprises a set of data object filters, the method further comprising applying the set of data object filters on the set of data objects to determine the subset of the set of data objects.

14. The method of claim 8, wherein the hierarchical rule definition further comprises an apply to child data object option, wherein the set of attributes comprises a parent data object identifier (ID), wherein, when the apply to child data object option is enabled, applying the hierarchical rule definition to each data object in the subset of the set of data objects is further by determining a set of child data objects of the data object based on the parent data object IDs of the set of data objects and modifying each data object in the set of child data objects in the same manner as the modification of the data object.

15. A system comprising:
a set of processing units; and
a non-transitory machine-readable medium storing instructions that when executed by at least one processing unit in the set of processing units cause the at least one processing unit to:
receive a request to apply a hierarchical rule definition to a set of data objects, each data object in the set of data objects comprising a set of attributes;
retrieve the hierarchical rule definition from a set of hierarchical rule definitions, wherein each hierarchical rule definition in the set of hierarchical rule definitions comprises a hierarchy of rules, each rule in the hierarchy of rules comprising a set of criteria and a set of actions that are performed when the set of criteria are satisfied; and
apply the hierarchical rule definition to each data object in a subset of the set of data objects by traversing the hierarchy of rules of the hierarchical rule definition and modifying the data object based on sets of criteria and sets of actions specified in the hierarchy of rules.

16. The system of claim 15, wherein the set of criteria of a particular rule in the hierarchy of rules comprises a child rule evaluation type, wherein the set of actions of the particular rule in the hierarchy of rules comprises setting a specified value for a particular attribute in the set of attributes.

17. The system of claim 16, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
evaluating at least one child rule of the particular rule in the hierarchy of rules on the data object; and
based on the evaluation, setting a value of the particular attribute of the data object to the specified value.

18. The system of claim 15, wherein the set of criteria of a particular rule in the hierarchy of rules comprises a first value for a first attribute in the set of attributes satisfies a condition, wherein the set of actions of the particular rule in the hierarchy of rules comprises setting a second value for a second attribute in the set of attributes.

19. The system of claim 18, wherein applying the hierarchical rule definition to each data object in the subset of the set of data objects by traversing the hierarchy of rules of the hierarchical rule definition and modifying the data object based on sets of criteria and sets of actions specified in the hierarchy of rules comprises:
determining whether the first value for the first attribute of the data object satisfies the condition; and
based on the determination, setting a value of the second attribute of the data object to the second value.

20. The system of claim 15, wherein each hierarchical rule definition in the set of hierarchical rule definitions further comprises a set of data object filters, wherein the instructions further cause the at least one processing unit to apply the set of data object filters on the set of data objects to determine the subset of the set of data objects.
